(19) United States
(12) Patent Application Publication
(10) Pub. No.: US 2013/0188483 A1
(43) Pub. Date: Jul. 25, 2013

(54) Resource Threshold Overload Protection

(71) Applicants: Brenda Teepell, Ottawa (CA); Robert A. Mann, Carp (CA)

(72) Inventors: Brenda Teepell, Ottawa (CA); Robert A. Mann, Carp (CA)

(73) Assignee: Alcatel-Lucent Canada, Inc., Ottawa (CA)

(21) Appl. No.: 13/354,853

(22) Filed: Jan. 20, 2012

(51) Int. Cl. H04L 12/26

(52) U.S. Cl. 370/235

(57) ABSTRACT

Various exemplary embodiments relate to a method of protecting against resource overload. The method may include: setting a resource critical threshold level of usage for a monitored resource; setting an overload rejection level for a plurality of operations; measuring a level of usage; determining an overload usage state based on the level of usage; shedding an operation if the overload usage state equals or exceeds the overload rejection level for the operation; determining whether the level of usage exceeds the resource critical threshold level; and if the level of usage exceeds the resource critical threshold level: changing the overload usage state to a resource critical overload usage state, and shedding an operation unless the overload rejection level indicates that the operation should never be shed. Various exemplary embodiments relate to a network element including: a monitored resource; a rejection level mapping; a status monitor; and an overload manager.

### TECHNICAL FIELD

Various exemplary embodiments disclosed herein relate generally to communications networks.

### BACKGROUND

In a communications network, a network element may process requests from a plurality of network nodes. If a network element receives requests faster than it can process the requests, the network element may become overloaded. An overloaded network element may perform inefficiently. If a network element becomes so overloaded that it can no longer process requests, the network element may crash and need to be reset. This may entail an interruption of service for the communications network.

A denial of service attack is a deliberate attempt to prevent access to a network resource. In one variety of denial of service attack, the attackers attempt to crash a network element by flooding the network element with requests. A denial of service attack may overload and crash the network element if the network element does not quickly manage the incoming requests.

### SUMMARY

In view of the foregoing, it would be desirable to provide a network element that manages its processing load. In particular, it would be desirable to provide a network element and method that recognizes that it has reached a resource critical point and responds by reducing the processing load before the network element crashes.

In light of the present need for a network element and method for managing overload to protect against crashes, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method of protecting against resource overload. The method may include; setting a resource critical threshold level of usage for a monitored resource; setting an overload rejection level for a plurality of operations processed by the monitored resource; measuring a level of usage of the monitored resource; determining an overload usage state based on the level of usage; shedding an operation if the overload usage state equals or exceeds the overload rejection level for the operation; determining whether the level of usage exceeds the resource critical threshold level; and if the level of usage exceeds the resource critical threshold level: changing the overload usage state to a resource critical overload usage state, and shedding an operation unless the overload rejection level indicates that the operation should never be shed.

In various alternative embodiments, the plurality of operations includes a plurality of requests to be processed by the monitored resource and an overload rejection level is set for a plurality of types of requests. The monitored resource may be a queue of received requests and the level of usage may be the size of the queue. The resource critical threshold level may be approximately 90% of a processing rate of the monitored resource times an expected timeout length of a request.

In various alternative embodiments, the step of determining an overload usage state includes: waiting an escalation interval; determining whether a monitored resource is in an overloaded state; and escalating the overload usage state if the monitored resource is in an overloaded state. The step of determining whether a monitored resource is in an overloaded state may include: determining that the monitored resource is in an overloaded state if the level of usage exceeds a first threshold; and determining that the monitored resource is not in an overloaded state if the level of usage falls below a second threshold, wherein the first threshold and the second threshold are less than the resource critical threshold.

In various alternative embodiments, only emergency messages should never be shed.

Various exemplary embodiments may relate to the above described methods encoded as instructions on a non-transitory machine-readable medium. The non-transitory machine-readable medium may include instructions that if executed by a processor of a network element perform the above described method.

Various exemplary embodiments relate to a network element including: a monitored resource configured to perform processing of a plurality of operations; a rejection level mapping configured to store an overload rejection level for the plurality of operations; a status monitor configured to: measure a level of usage of the monitored resource, determine an overload usage state of the monitored resource based on an amount of time that the level of usage exceeds a first threshold, and determine that the monitored resource is in a resource critical usage state if a measurement of resource usage exceeds a resource critical threshold; and an overload manager configured to: shed an operation if the overload usage state equals or exceeds the overload rejection level of the operation, and shed all operations that are allowed to be shed if the monitored resource is in a resource critical usage state.

In various alternative embodiments, the plurality of operations include a plurality of requests to be processed by the monitored resource and the rejection level mapping stores an overload rejection level for a plurality of request types. The monitored resource may be a queue of received requests and the status monitor is configured to measure the size of the queue. The resource critical threshold level may be approximately 90% of a processing rate of the monitored resource times an expected timeout length of a request.

In various alternative embodiments, the status monitor is configured to: determine that the monitored resource is in an overloaded state; wait an escalation interval; determine whether the monitored resource remains in an overloaded state; and escalate the overload usage state if the monitored resource remains in an overloaded state. The status monitor may be configured to: determine that the monitored resource is in an overloaded state if the level of usage exceeds a first threshold; and determine that the monitored resource is not in an overloaded state if the level of usage falls below a second threshold, wherein the first threshold and the second threshold are less than the resource critical threshold.

In various alternative embodiments, the load manager is allowed to shed all operations except requests for emergency services.

In various alternative embodiments, the network element further includes a plurality of monitored resources, wherein the status monitor is configured to determine a system overload usage state based on the amount of time that at least one of the plurality of monitored resources has been in an overload state.

It should be apparent that, in this manner, various exemplary embodiments enable a network element and method for managing overload to protect against crashes. In particular, by setting a resource critical threshold and shedding all non-emergency requests when above the resource critical threshold, a network element may protect against a sudden increase in requests.

### BRIEF DESCRIPTION OF THE DRAWINGS

In order to better understand various exemplary embodiments, reference is made to the accompanying drawings, wherein:

FIG. 1 illustrates an exemplary subscriber network;

FIG. 2 illustrates an exemplary network element;

FIG. 3 illustrates an exemplary data structure for mapping various operations to overload rejection levels; and

FIG. 4 illustrates a state diagram showing possible overload states of a monitored resource;

FIG. 5 illustrates a flowchart showing an exemplary method of determining a system overload state; and

FIG. 6 illustrates a flowchart showing an exemplary method of processing operations based on the system overload state.

### DETAILED DESCRIPTION

Referring now to the drawings, in which like numerals refer to like components or steps, there are disclosed broad aspects of various exemplary embodiments.

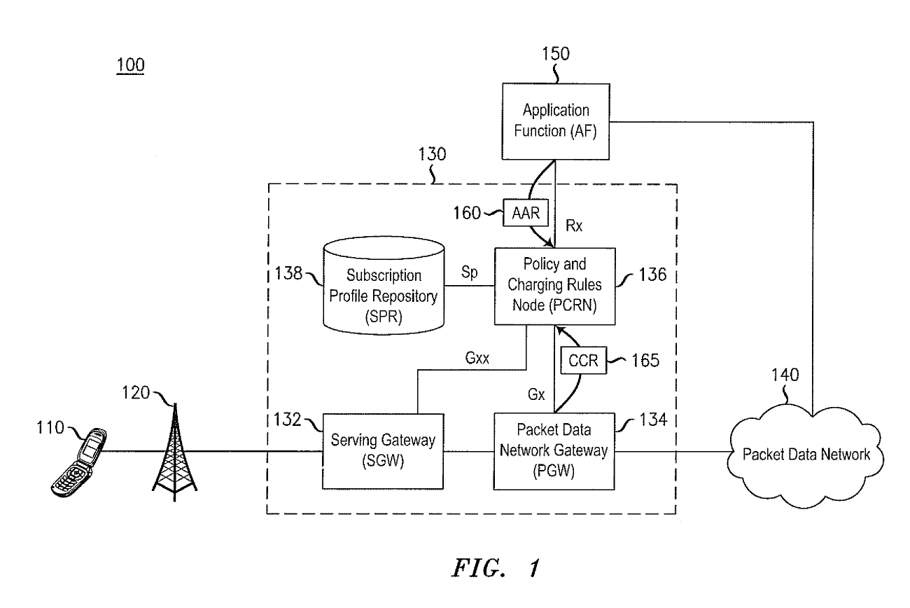

FIG. 1 illustrates an exemplary subscriber network 100 for providing various data services. Exemplary subscriber network 100 may be a telecommunications network or other network for providing access to various services. In various embodiments, subscriber network 100 may be a public land mobile network (PLMN). Exemplary subscriber network 100 may include user equipment 110, base station 120, evolved packet core (EPC) 130, packet data network 140, and application function (AF) 150.

User equipment 110 may be a device that communicates with packet data network 140 for providing the end-user with a data service. Such data service may include, for example, voice communication, text messaging, multimedia streaming, and Internet access. More specifically, in various exemplary embodiments, user equipment 110 is a personal or laptop computer, wireless email device, cell phone, tablet, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by 3GPP standards. Thus, base station 120 may be a device that communicates with user equipment 110 via a first medium, such as radio waves, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various alternative embodiments, user equipment 110 may communicate directly with EPC 130. In such embodiments, base station 120 may not be present.

Evolved packet core (EPC) 130 may be a device or network of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the 3GPP TS 29.212, 29.213, and 29.214 standards. Accordingly, EPC 130 may include a serving gateway (SGW) 132, a packet data network gateway (PGW) 134, a policy and charging rules node (PCRN) 136, and a subscription profile repository (SPR) 138.

Serving gateway (SGW) 132 may be a device that provides gateway access to the EPC 130. SGW 132 may be one of the first devices within the EPC 130 that receives packets sent by user equipment 110. Various embodiments may also include a mobility management entity (MME) (not shown) that receives packets prior to SGW 132. SGW 132 may forward such packets toward PGW 134. SGW 132 may forward such packets toward PGW 134. SGW 132 may perform a number of functions such as, for example, managing mobility of user equipment 110 between multiple base stations (not shown) and enforcing particular quality of service (QoS) characteristics for each flow being served. In various implementations, such as those implementing the Proxy Mobile IP standard, SGW 132 may include a Bearer Binding and Event Reporting Function (BBERF). In various exemplary embodiments, EPC 130 may include multiple SGWs (not shown) and each SGW may communicate with multiple base stations (not shown).

Packet data network gateway (PGW) 134 may be a device that provides gateway access to packet data network 140. PGW 134 may be the final device within the EPC 130 that receives packets sent by user equipment 110 toward packet data network 140 via SGW 132. PGW 134 may include a policy and charging enforcement function (PCEF) that enforces policy and charging control (PCC) rules for each service data flow (SDF). Therefore, PGW 134 may be a policy and charging enforcement node (PCEN). PGW 134 may include a number of additional features such as, for example, packet filtering, deep packet inspection, and subscriber charging support. PGW 134 may also be responsible for requesting resource allocation for unknown application services.

Policy and charging rules node (PCRN) 136 may be a device or group of devices that receives requests for application services, generates PCC rules, and provides PCC rules to the PGW 134 and/or other PCENs (not shown). PCRN 136 may be in communication with AF 150 via an Rx interface. PCRN 136 may receive an application request in the form of an Authentication and Authorization Request (AAR) 160 from AF 150. Upon receipt of AAR 160, PCRN 136 may generate at least one new PCC rule for fulfilling the application request 160.

PCRN 136 may also be in communication with SGW 132 and PGW 134 via a Gxx and a Gx interface, respectively. PCRN 136 may receive an application request in the form of a credit control request (CCR) 165 from SGW 132 or PGW 134. As with AAR 160, upon receipt of CCR 165, PCRN 136 may generate at least one new PCC rule for fulfilling the application request. In various embodiments, AAR 160 and CCR 165 may represent two independent application requests to be processed separately, while in other embodiments, AAR 160 and CCR 165 may carry information regarding a single application request and PCRN 136 may create at least one PCC rule based on the combination of AAR 160 and CCR 165. In various embodiments, PCRN 136 may be capable of handling both single-message and paired-message application requests.

Upon creating a new PCC rule or upon request by the PGW 134, PCRN 136 may provide a PCC rule to PGW 134 via the Gx interface. In various embodiments, such as those implementing the PMIP standard for example, PCRN 136 may also generate QoS rules. Upon creating a new QoS rule or upon request by the SGW 132, PCRN 136 may provide a QoS rule to SGW 132 via the Gxx interface.

Subscription profile repository (SPR) 138 may be a device that stores information related to subscribers to the subscriber network 100. Thus, SPR 138 may include a machine-readable storage medium such as read-only memory (ROM), random-access memory (RAM), magnetic disk storage media, optical storage media, flash-memory devices, and/or similar storage media. SPR 138 may be a component of PCRN 136 or may constitute an independent node within EPC 130. Data stored by SPR 138 may include an identifier of each subscriber and indications of subscription information for each subscriber such as bandwidth limits, charging parameters, and subscriber priority.

Packet data network 140 may be any network for providing data communications between user equipment 110 and other devices connected to packet data network 140, such as AF 150. Packet data network 140 may further provide, for example, phone and/or Internet service to various user devices in communication with packet data network 140.

Application function (AF) 150 may be a device that provides a known application service to user equipment 110. Thus, AF 150 may be a server or other device that provides, for example, a video streaming or voice communication service to user equipment 110. AF 150 may further be in communication with the PCRN 136 of the EPC 130 via an Rx interface. When AF 150 is to begin providing known application service to user equipment 110, AF 150 may generate an application request message, such as an authentication and authorization request (AAR) 160 according to the Diameter protocol, to notify the PCRN 136 that resources should be allocated for the application service. This application request message may include information such as an identification of the subscriber using the application service, an IP address of the subscriber, an APN for an associated IP-CAN session, and/or an identification of the particular service data flows that must be established in order to provide the requested service. AF 150 may communicate such an application request to the PCRN 136 via the Rx interface.

It should be apparent that a network element such as PCRN 136 may receive and process a large number of requests such as AAR 160 and CCR 165. Requests may arrive at any time and may arrive in large numbers suddenly. For example, a denial of service attack or a natural disaster may result in a sudden spike in the number of requests that could potentially overload PCRN 136. As will be described in further detail below, PCRN 136 may include hardware and/or software to protect the network element from crashing due to overload. In particular, PCRN 136 may shed requests if it becomes overloaded. PCRN 136 may also perform other operations such as background tasks. In various exemplary embodiments, PCRN 136 may shed any operation to prevent crashing due to overload.

Other network elements of subscriber network 100 may also receive a large number of requests. The systems and methods described herein may be applicable to any network element with a varying processing load that is subject to crashing due to overload. For example, a server such as a Simple Object Access Protocol (SOAP) server may receive and process a large number of requests.

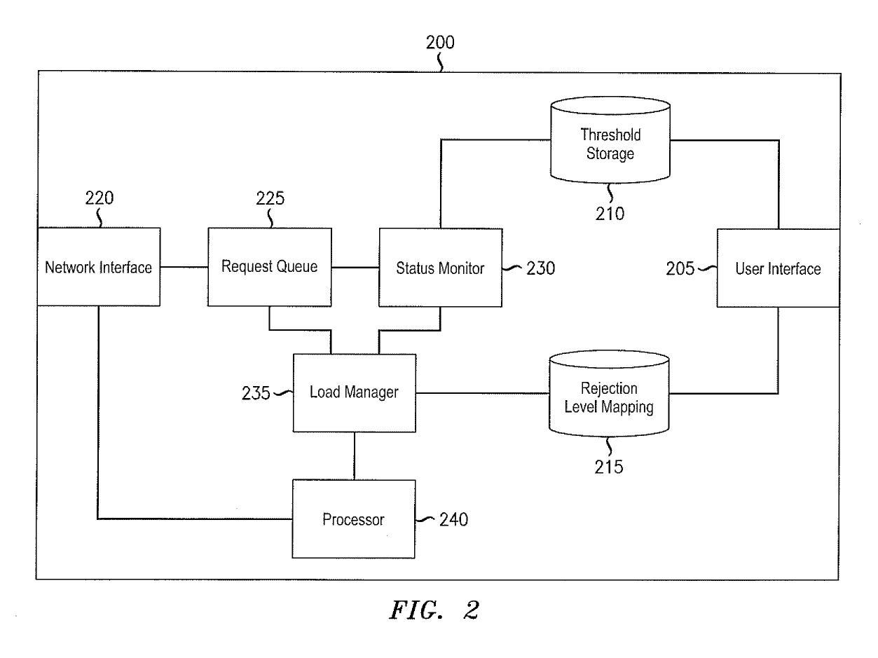

FIG. 2 illustrates an exemplary network element 200. Network element 200 may be PCRN 136 or another network element that receives and processes requests. Network element 200 may include user interface 205, threshold storage 210, rejection level mapping 215, network interface 220, request queue 225, status monitor 230, load manager 235, and processor 240.

User interface 205 may include hardware and/or executable instructions encoded on a machine-readable storage medium configured to provide a network operator with access to network element 200. User interface 205 may receive input from a network operator and may include hardware such as, for example, a keyboard and/or mouse. User interface 205 may also display information as output to the network operator and may include, for example, a monitor. A network operator may configure threshold storage 210 and rejection level mapping 215 via user interface 205. User interface 205 may provide a network operator with various options for creating or modifying threshold storage 210 and rejection level mapping 215.

Threshold storage 210 may include any machine-readable medium capable of storing threshold information for use by network element 200. Accordingly, threshold storage 210 may include a machine-readable storage medium such as read-only memory (ROM), random-access memory (RAM), magnetic disk storage media, optical storage media, flash-memory devices, and/or similar storage media. Threshold storage 210 may store threshold information for one or more monitored resources within network element 200. Threshold information may include a high threshold, a low threshold, one or more escalation intervals, and a resource critical threshold. The values and units for the threshold information may be configured by a network operator via user interface 205 and may vary depending on the monitored resource. The high threshold may indicate a point at which the monitored resource becomes overloaded. The low threshold may indicate a point at which the monitored resource has reduced processing load to a point where it is no longer overloaded. The escalation interval may indicate an amount of time the monitored resource is allowed to remain overloaded before an overload usage state is escalated. The threshold information may include different escalation intervals for each overload usage state. The resource critical threshold may indicate a point at which the monitored resource is in danger of failure. The resource critical threshold may be higher than both the low threshold and the high threshold. Threshold storage 210 may be accessed by status monitor 230.

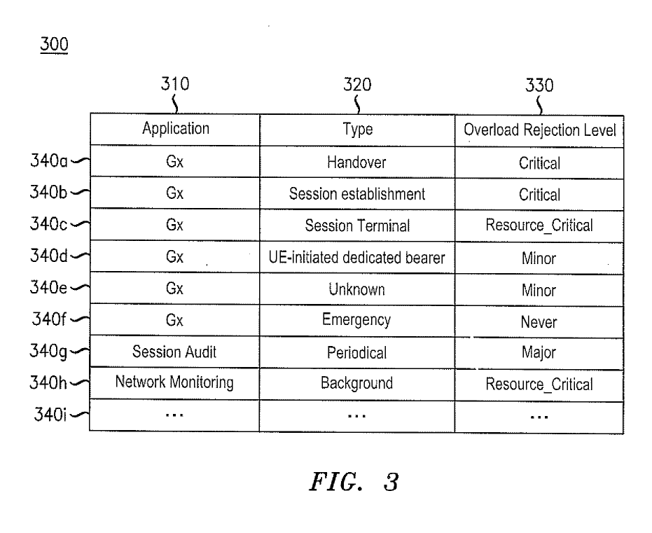

Rejection level mapping 215 may include any machine-readable medium capable of storing rejection level information for use by network element 200. Accordingly, rejection level mapping 215 may include a machine-readable storage medium such as read-only memory (ROM), random-access memory (RAM), magnetic disk storage media, optical storage media, flash-memory devices, and/or similar storage media. As will be described in further detail below with respect to FIG. 3, rejection level mapping 215 may include an overload rejection level for each operation performed by network element 200. Rejection level mapping 215 may be used by load manger 235 to determine whether to shed an operation due to overload. The overload rejection levels may correspond to overload usage states determined by status monitor 230.

Network interface 220 may be an interface comprising hardware and/or executable instructions encoded on a machine-readable storage medium configured to communicate with other network elements. Network interface 220 may receive requests such as, for example, AAR 160 and CCR 165. Network interface 220 may forward received requests to request queue 225. Network interface 220 may also send outgoing messages to other network elements. In various exemplary embodiments, network interface 220 may communicate using the Diameter protocol. Network interface 220 may receive and send messages within multiple applications such as, for example, Gx, Gxx, Rx, Sp, and S9. In various alternative embodiments, network element 220 may include multiple network interfaces.

Request queue 225 may include a memory for storing received requests before they are processed. Request queue 225 may be a monitored resource with thresholds defined for the length of the queue. The length of request queue 225 may provide an effective measurement for the load on network element 200. In various alternative embodiments, other components of network element 200 may be monitored resources. For example, a CPU may be a monitored resource and the level of usage may be monitored by CPU load or processing latency. As another example, the memory may be a monitored resource and the level of usage may be monitored by memory usage.

Status monitor 230 may include hardware and/or executable instructions encoded on a machine-readable storage medium configured to determine the overload state of a monitored resource and the network element 200. Status monitor 230 may determine whether a monitored resource is overloaded. Status monitor 230 may measure a level of usage of a monitored resource. For example, status monitor 230 may measure the length of request queue 225. Status monitor 230 may compare the level of usage to the threshold information defined for the monitored resource in threshold storage 210. A monitored resource may become overloaded when a level of usage exceeds the high threshold defined in threshold storage 210. A monitored resource may leave the overloaded state when the level of usage falls below the low threshold defined in threshold storage 210. In various exemplary embodiments including multiple monitored resources, status monitor 230 may determine that network element 200 is overloaded if any one of the monitored resources is overloaded.

Status monitor 230 may determine an overload usage state for the monitored resource. In various exemplary embodiments, status monitor 230 may choose between 1: normal, 2: minor, 3: major, 4: critical, and 5: resource critical. These overload usage states may be defined in a management information base (MIB) and communicated using simple network management protocol (SNMP). Status monitor 230 may determine an overload usage state of the resource according to both an amount of time spent overloaded and the resource critical threshold. When status monitor 230 first determines that the monitored resource is overloaded, status monitor 230 may set the overload usage state to 2: minor. If the monitored resource remains in an overloaded state for the escalation interval, status monitor 230 may increment the overload usage state to 3: major, then to 4: critical after another escalation interval. In various exemplary embodiments, 4: critical may be the highest overload usage state that status monitor 230 may assign based on being in an overloaded state. Accordingly, a monitored resource may remain in the 4: critical state until the monitored resource is no longer overloaded. If status monitor 230 detects that the level of usage has decreased below the low threshold, status monitor 230 may change the overload usage state to 1: normal.

Status monitor 230 may also compare the level of usage to the resource critical threshold. The resource critical threshold may be set by network operator using user interface 205. The resource critical threshold may indicate a point where a monitored resource is likely to fail or become ineffective. For example, a request queue may fail when the length of the queue is so long that requests expire before they reach the front of the queue. Accordingly a resource critical threshold of approximately 90% of the processing rate times the average request expiration time may be an effective resource critical threshold for a request queue. If the level of usage exceeds the resource critical threshold, status monitor 230 may determine that the monitored resource is in a resource critical state. Status monitor 230 may immediately change the overload usage state to 5: resource critical, the highest overload usage state, when the monitored resource is in a resource critical state. Status monitor 230 may transition directly to usage state 5: resource critical from any other usage state. The overload usage state may remain at 5: resource critical until the level of usage decreases below the resource critical threshold. Status monitor 230 may pass the overload usage state of the monitored resource to load manager 235.

Load manager 235 may include hardware and/or executable instructions encoded on a machine-readable storage medium configured to determine whether to shed an operation. Load manager 235 may receive an operation from request queue 225 and determine the type of request. Load manager 235 may then use rejection level mapping 215 to determine the overload rejection level for the type of request. Load manager 235 may then compare the overload rejection level to the overload usage state of a monitored resource. If the overload rejection state is equal to or greater than the overload rejection level, load manager 235 may shed the operation. Load manager 235 may send a notification to the network element that sent the request to indicate that the network element 200 is too busy to process the request. If load manager 235 does not shed the operation, the operation may be sent to processor 240 for processing.

Processor 240 may include hardware and/or executable instructions encoded on a machine-readable storage medium configured to perform operations. In various exemplary embodiments where network element 200 is a PCRN, operations may include processing a request. Processor 240 may determine whether to fulfill the request and generate appropriate messages for fulfilling the request. Processor 240 may access other components such as, for example, memories, tables, databases, and interfaces for fulfilling the request. Operations processed by processor 240 may also include other functions performed by network element 200. For example, processor 240 may perform network management functions as background operations. Background operations may consume the same resources as request operations. Load manager 235 may shed background operations to allow processor 240 to process more request operations.

In various alternative embodiments, processor 240 may be a monitored resource. Status monitor 230 may measure the level of usage of processor 240 by the percentage of cycles where the processor 240 is active. Threshold storage 210 may include different percentages as high, low, and resource critical thresholds. For example, a resource critical threshold may be set at 90% to prevent a processor from crashing.

FIG. 3 illustrates an exemplary data structure 300 for mapping various operations to overload rejection levels. It should be apparent that data structure 300 may be implemented using a variety of data structures such as, for example, objects, arrays, linked lists, or trees. Data structure 300 may be stored in rejection level mapping 215 or another computer-readable storage medium accessible to network element 200. Data structure 300 may include application field 310, type field 320, and overload rejection level field 330. Data structure 300 may also include a plurality of entries 340a-i.

Application field 310 may indicate an application associated with an operation. If the operation is processing a Diameter request, application field 310 may indicate the Diameter application of the request. Data structure 300 may include more than one entry 340 for a Diameter application. If the operation is a process other than a request, application field 310 may indicate the name of the process.

Type field 320 may indicate a type of the operation. If the operation is processing a Diameter request, type field 320 may indicate the type of request for the application. Data structure 300 may include more than one entry 340 for a type of request. Data structure 300, however, may include only one entry 340 for each unique combination of application field 310 and type field 320. If the operation is not processing a request, type field 320 may indicate information such as the frequency of the operation.

Overload rejection level field 330 may indicate a level at which load manager 235 should shed an operation. An entry 340 for overload rejection level field 330 may indicate an overload usage state. In various exemplary embodiments, possible entries in overload rejection level field 330 may include 2: minor, 3: major, 4: critical, and 5: resource critical. Overload usage state 1: normal, however, may not be used because there may be no need to shed entries when the monitored resource is not overloaded. An entry 340 for an overload rejection level field 330 may also indicate that the operation should never be shed. In various exemplary embodiments, only an entry 340 for emergency requests may indicate that the operation should never be shed.

In order to illustrate the use of data structure 300, exemplary entries 340a-i are provided to show possible configurations of rejection level mapping 215. The exemplary entries 340a-i may be used for a network element such as PCRN 136. It should be understood that data structure 300 may be configured by a network operator for other network elements based on the operations performed by the network element.

Exemplary entry 340a may indicate that a Gx request for a handover should be shed when a monitored resource reaches the 4: critical overload usage state. Exemplary entry 340b may indicate that a Gx request for a session establishment should be shed when a monitored resource reaches the 4: critical overload usage state. Exemplary entry 340c may indicate that a Gx request for session termination should be shed when a monitored resource reaches the 5: resource critical overload usage state. Exemplary entry 340d may indicate that a Gx request for a UE initiated dedicated bearer should be shed when a monitored resource reaches the 2: minor overload usage state. Exemplary entry 340e may indicate that a Gx request for an unknown service should be shed when a monitored resource reaches the 2: minor overload usage state. Exemplary entry 340f may indicate that a Gx request for an emergency service should never be shed. Exemplary entry 340g may indicate that a session audit application runs periodically, but may be shed when a monitored resource reaches the 3: major overload usage state. Exemplary entry 340h may indicate that a network monitoring application runs in the background, but may be shed when a monitored resource reaches the 5: resource critical usage state. Exemplary entry 340i may indicate that data structure 300 may include additional entries. For example, data structure 300 may include entries for additional Diameter applications, additional request types, and/or additional processes.

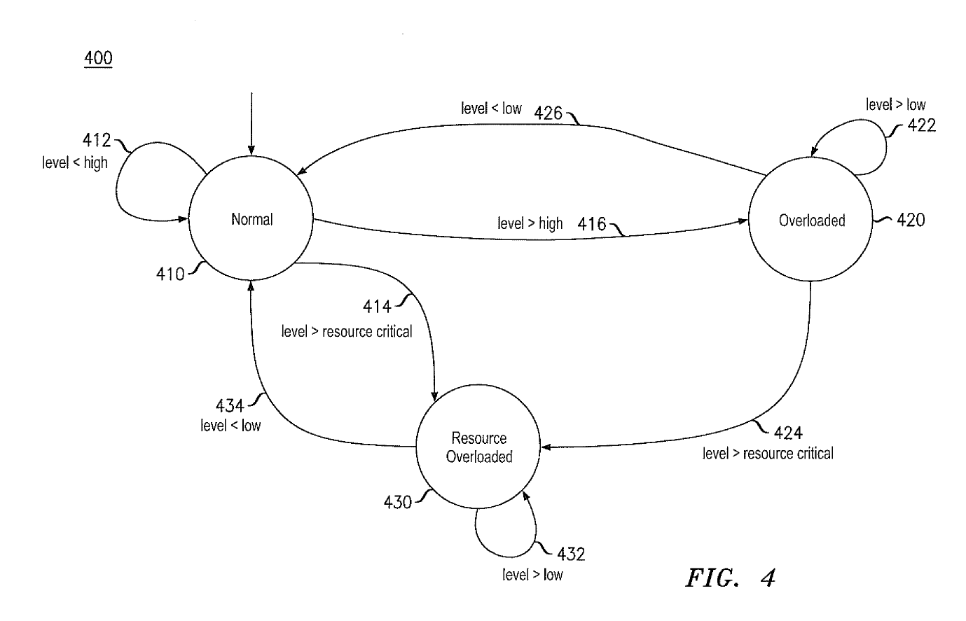

FIG. 4 illustrates a state diagram 400 showing possible overload states of a monitored resource. A monitored resource may have three possible states: normal 410, overloaded 420, and resource overloaded 430. Each monitored resource of network element 200 may continually measure a level of usage and compare the level of usage with the high, low and resource critical thresholds configured for the monitored resource. The monitored resource may transition between states based on the comparison between the level of usage and the thresholds.

Normal state 410 may indicate that the monitored resource is functioning as intended. The monitored resource may begin in the normal state 410 when the system starts. In the normal state 410, the monitored resource may be performing operations without any reduction in performance. The monitored resource may remain in the normal state 410 by following transition path 412 when the level of usage is less than the high threshold. The monitored resource may transition to the overloaded state 420 by following transition path 416 when the level of usage is greater than the high threshold, but less than the resource critical threshold. The monitored resource may transition to the resource overloaded state by following transition path 414 when the level of usage is greater than the resource critical threshold.

Overloaded state 420 may indicate that the monitored resource is overloaded. The monitored resource may be attempting to process too many operations. The monitored resource may be operating inefficiently because of, for example, time spent waiting in queues or switching between operations. The monitored resource may remain in the overloaded state 420 by following transition path 422 when the level of usage is greater than the low threshold. The monitored resource may transition to the normal state 410 by following the transition path 426 when the level of usage is less than the low threshold. The monitored resource may transition to the resource overloaded state 430 by following the transition path 424 when the level of usage is greater than the resource critical threshold.

Resource overloaded state 430 may indicate that the monitored resource is severely overloaded and in danger of crashing or becoming ineffective. The monitored resource may be ineffective because, for example, an operation times out before it reaches the front of a processing queue. The monitored resource may remain in the resource overloaded state 430 by following the transition path 432 when the level of usage is greater than the low threshold. The monitored resource may transition to the normal state 410 by following the transition path 434 when the level of usage is less than the low threshold.

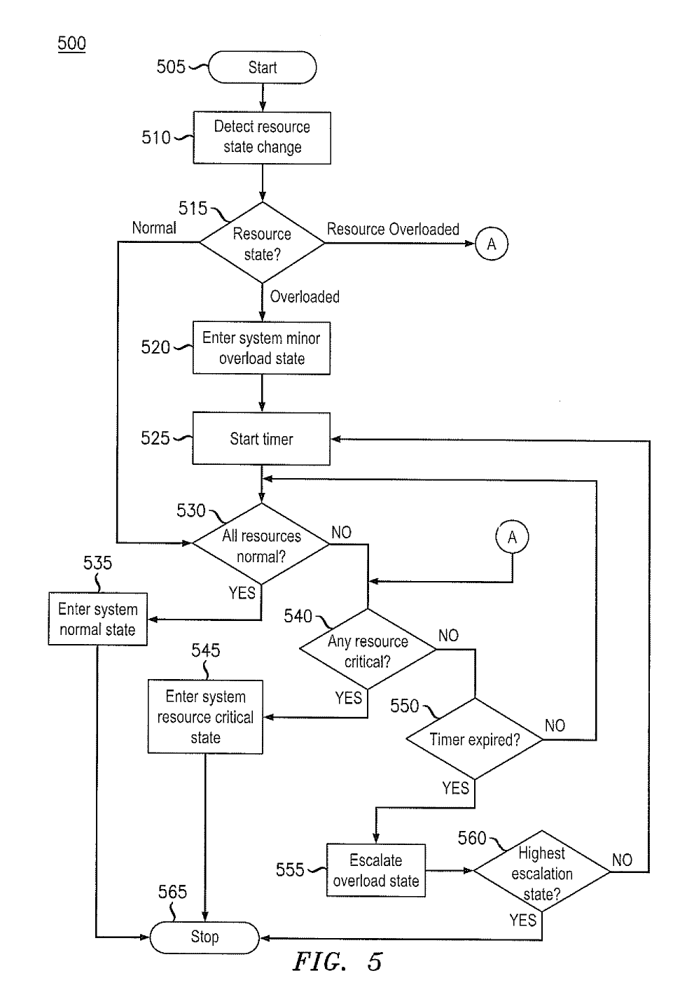

FIG. 5 illustrates a flowchart showing an exemplary method 500 of determining a system overload state. In various exemplary embodiments, the system overload state may describe a network element 200 including one or more monitored resources. The method 500 may be performed by the various components of the network element 200. The method 500 may begin in step 505 and proceed to step 510.

In step 510, the network element 200 may detect that a monitored resource has changed state. The state of the monitored resource may change as described above regarding FIG. 4. In various exemplary embodiments, the monitored resources may report their usage state to a component such as status monitor 230. The method 500 may then proceed to step 515.

In step 515, the network element 200 may determine the state to which the monitored resource has transitioned. As discussed above regarding FIG. 4, a monitored resource may transition into normal state 410, overloaded state 420, or resource overloaded state 430. If the monitored resource has transitioned into normal state 410, the method 500 may proceed to step 530. If the monitored resource has transitioned into overloaded state 420, the method 500 may proceed to step 520. If the monitored resource has transitioned into resource overloaded state 530, the method 500 may proceed to step 540.

In step 520, the network element 200 may enter a system minor overload state. The system minor overload state may be the lowest escalation level of the system overload state. In various exemplary embodiments, step 520 may occur only if the network element 200 is in a normal state. The network element 200 may already be in an overloaded state because another monitored resource may be overloaded. If the network element 200 is already in an overloaded state, the method 500 may skip step 520 and proceed to step 530. Once network element 200 has entered a minor overload state, the method 500 may proceed to step 525.

In step 525, the network element 200 may start an escalation timer. The length of the escalation timer may be configured along with the threshold levels. In various exemplary embodiments, the escalation timer may measure a fixed amount of time. In various alternative embodiments, the escalation timer may measure a number of processor cycles or number of operations processed. Once the escalation timer has started, the method may proceed to step 530.

In step 530, the network element 200 may determine whether all monitored resources are in normal state 410. If all monitored resources are in the normal state 410, the method 500 may proceed to step 535. If at least one resource is in an overloaded state (overloaded state 420 or resource overloaded state 430), the method 500 may proceed to step 540.

In step 535, the network element 200 may enter a system normal state. In the system normal state, the network element 200 may function normally and process all operations. The method 500 may proceed from step 535 to step 565 where the method ends.

In step 540, the network element 200 may determine whether any monitored resource is in a resource overloaded state 530. A monitored resource may be in a resource overloaded state 530 because the monitored resource transitioned to the resource overloaded state 530 in step 510. Another monitored resource may have already been in resource overloaded state 530. If any resource is in resource overloaded state 530, the method 500 may proceed to step 545. If no resources are in resource overloaded state 530, the method may proceed to step 530.

In step 545, the network element 200 may enter the system resource critical state. In the system resource critical state, the network element 200 may shed all operations except emergency requests. Shedding all non-emergency operations may reduce the level of usage of the monitored resource. The method 500 may proceed from step 545 to step 565 where the method ends.

In step 550, the network element 200 may determine whether the escalation timer set in step 525 has expired. If the escalation timer has expired, the method 500 may proceed to step 555. If the escalation timer has not expired, the method 500 may return to step 530. The method 500 may repeat steps 530, 540, and 550 until the escalation timer has expired or the overload state of another resource has changed. In this manner, the network element 200 may wait for the escalation timer to expire.

In step 555, the network element 200 may escalate the system overload state. The network element 200 may increase the level of the system overload state by one level. In various exemplary embodiments, the network element 200 may escalate from 2: minor to 3: major to 4: critical. The method 500 may then proceed to step 555.

In step 555, the network element 200 may determine whether it is in the highest escalation state. In various exemplary embodiments, 4: critical is the highest escalation state. If the network element 200 is in 4: critical, the method 500 may proceed to step 565, where the method 500 ends. If the network element 200 is not in the highest escalation state, the method 500 may return to step 525, where the network element 200 may restart the escalation timer. The system state of 5: resource critical may be reached only if a monitored resource is in a resource critical state 530. As such, system state 5: resource critical may not be considered an escalation state.

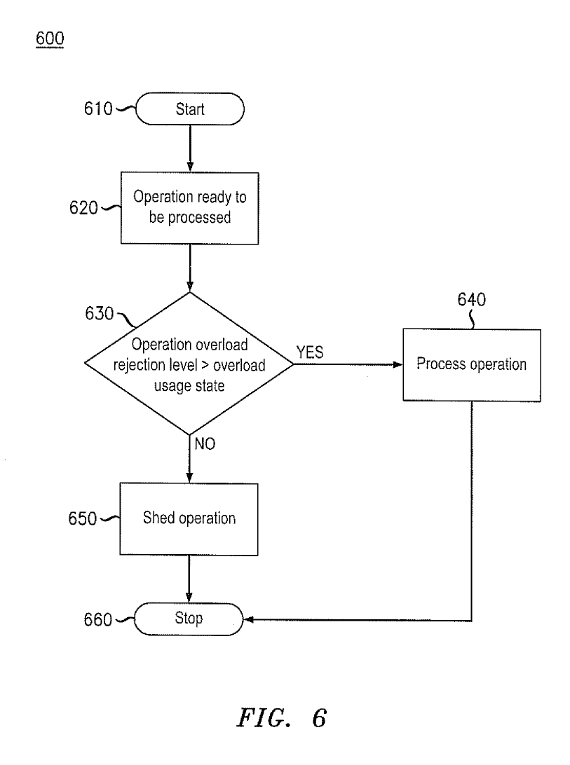

FIG. 6 illustrates a flowchart showing an exemplary method of processing operations based on the system overload state. The method 600 may be performed by the various components of a network element 200. The method 600 may begin at step 610 and proceed to step 620.

In step 620, the network element 200 may determine that an operation is ready to be processed. For example, an operation may reach the front of a queue such as request queue 225. The method 600 may then proceed to step 630.

In step 630, the network element 200 may determine whether the operation rejection level is greater than the overload usage state. The network element may, for example, look up the operation rejection level in a data structure such as data structure 300. The overload usage state may be the current system overload usage state as determined by, for example, method 500. If the operation overload rejection level is greater than the overload usage state, the method 600 may proceed to step 640. If the operation overload rejection level is less than or equal to the overload usage state, the method 600 may proceed to step 650.

In step 640, the network element 200 may process the operation. For example, the network element 200 may respond to a Diameter request message. Performing step 640 may use one or more monitored resources. Once the operation is processed, the method 600 may proceed to step 660, where the method 600 ends.

In step 650, the network element 200 may shed the operation. For example, the network element 200 may deny a Diameter request message or ignore the message and provide no response. Step 650 may not use the monitored resource or may use the monitored resource less than step 640. Accordingly, shedding an operation in step 650 may reduce the level of usage of the monitored resource. Once the network element 200 has shed the operation, the method 600 may proceed to step 660, where the method 600 ends.

Having described various components of network element 200 and methods for preventing overload, a brief example of the operation of network element 200 will be described. A network operator may configure thresholds and overload rejection levels before or while the network element 200 is running. In this example, the request queue 225 may be the monitored resource and thresholds may be configured as low=500, high=1000, resource critical=2000, and escalation interval=30 seconds. In various alternative embodiments, different escalation intervals may be configured for each overload usage state. The rejection level mapping 215 may be configured as shown in FIG. 3. Network element 200 may begin in the 1: normal overload usage state and be efficiently processing incoming requests. Network element 200 may then receive a large number of requests such that the queue size is increased to 1500. Network element 200 may measure the queue size, determine that the request queue 225 is now overloaded, and transition the request queue into an overloaded state. The network element 200 may detect the overloaded monitored resource and escalate the overload usage state to 2: minor. In this state, network element 200 may shed low priority messages such as UE initiated dedicated bearer requests and unknown requests. Network element 200 may wait for the escalation interval of 30 seconds before changing to overload usage state 3: major. If, however, network element 200 continues to receive more requests than it can process or shed, the queue size may increase above 2000 before the 30 seconds have elapsed. When the queue size crosses the resource critical threshold of 2000, the request queue may transition to the resource overloaded state. Network element 200 may detect the state change of the monitored resource and immediately enter the overload usage state 5: resource critical. Network element 200 may then shed all requests except emergency requests. Network element 200 may also stop processes such as a session audit and network monitoring. These actions may prevent network element 200 from becoming ineffective or crashing. Because emergency requests are expected to be a small percentage of the incoming requests, network element 200 may quickly reduce the queue size by shedding requests. Once the queue size is reduced below the low threshold of 500, the request queue may then transition to the normal state. If no other monitored resources are overloaded, network element 200 may also transition to the normal state. If other monitored resources are still overloaded, network element 200 may transition to the previous overload usage state of 2: minor and continue shedding low priority requests until the overloaded monitored resource level of usage falls below the low threshold.

According to the foregoing, various exemplary embodiments provide for a network element and method for managing overload to protect against crashes. In particular, by setting a resource critical threshold and shedding all non-emergency requests when above the resource critical threshold, a network element may protect against a sudden increase in requests. It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of protecting against resource overload, the method comprising:
setting a resource critical threshold level of usage for a monitored resource;
setting an overload rejection level for a plurality of operations processed by the monitored resource;
measuring a level of usage of the monitored resource;
determining an overload usage state based on the level of usage;
shedding an operation if the overload usage state equals or exceeds the overload rejection level for the operation;
determining whether the level of usage exceeds the resource critical threshold level; and
if the level of usage exceeds the resource critical threshold level:
changing the overload usage state to a resource critical overload usage state, and
shedding an operation unless the overload rejection level indicates that the operation should never be shed.

2. The method of claim 1, wherein the plurality of operations include a plurality of requests to be processed by the monitored resource and an overload rejection level is set for a plurality of types of requests.

3. The method of claim 2, wherein the monitored resource is a queue of received requests and the level of usage is the size of the queue.

4. The method of claim 3, wherein the resource critical threshold level is approximately 90% of a processing rate of the monitored resource times an expected timeout length of a request.

5. The method of claim 1, wherein the step of determining an overload usage state comprises
waiting an escalation interval;
determining whether a monitored resource is in an overloaded state; and
escalating the overload usage state if the monitored resource is in an overloaded state.

6. The method of claim 5, wherein the step of determining whether a monitored resource is in an overloaded state comprises:
determining that the monitored resource is in an overloaded state if the level of usage exceeds a first threshold; and
determining that the monitored resource is not in an overloaded state if the level of usage falls below a second threshold,
wherein the first threshold and the second threshold are less than the resource critical threshold.

7. The method of claim 1, wherein only emergency messages should never be shed.

8. The method of claim 1, wherein the steps of measuring a level of usage, determining an overload usage state, determining whether the level of usage exceeds the resource critical threshold level, and shedding an operation are repeated.

9. A network element comprising;
a monitored resource configured to perform processing of a plurality of operations;
a rejection level mapping device configured to store an overload rejection level for the plurality of operations;
a status monitor device configured to;
measure a level of usage of the monitored resource,
determine an overload usage state of the monitored resource based on an amount of time that the level of usage exceeds a first threshold, and
determine that the monitored resource is in a resource critical usage state if a measurement of resource usage exceeds a resource critical threshold; and
an overload manager device configured to:
shed an operation if the overload usage state equals or exceeds the overload rejection level of the operation, and
shed all operations that are allowed to be shed if the monitored resource is in a resource critical usage state.

10. The network element of claim 8, wherein the plurality of operations include a plurality of requests to be processed by the monitored resource and the rejection level mapping device stores an overload rejection level for a plurality of request types.

11. The network element of claim 9, wherein the monitored resource is a queue of received requests and the status monitor is configured to measure the size of the queue.

12. The network element of claim 9, wherein the resource critical threshold level is approximately 90% of a processing rate of the monitored resource times an expected timeout length of a request.

13. The network element of claim 8, wherein the status monitor device is configured to:
determine that the monitored resource is in an overloaded state;
wait an escalation interval;
determine whether the monitored resource remains in an overloaded state; and
escalate the overload usage state if the monitored resource remains in an overloaded state.

14. The network element of claim 12, wherein the status monitor device is configured to:
determine that the monitored resource is in an overloaded state if the level of usage exceeds a first threshold; and
determine that the monitored resource is not in an overloaded state if the level of usage falls below a second threshold,
wherein the first threshold and the second threshold are less than the resource critical threshold.

15. The network element of claim 8, wherein the load manager device is allowed to shed all operations except requests for emergency services.

16. The network element of claim 8, further comprising a plurality of monitored resources, wherein the status monitor device is configured to determine a system overload usage state based on the amount of time that at least one of the plurality of monitored resources has been in an overload state.

17. A tangible and non-transitory machine-readable storage medium encoded with instructions thereon for execution by a network element of a telecommunication network, wherein said tangible and non-transitory machine-readable storage medium comprises:
instructions for setting a resource critical threshold level of usage for a monitored resource;
instructions for setting an overload rejection level for a plurality of operations processed by the monitored resource;
instructions for measuring a level of usage of the monitored resource;
instructions for determining an overload usage state based on the level of usage;
instructions for shedding an operation if the overload usage state equals or exceeds the overload rejection level for the operation;
instructions for determining whether the level of usage exceeds the resource critical threshold level; and
instructions for changing the overload usage state to a resource critical overload usage state and shedding an operation if the level of usage exceeds the resource critical threshold level unless the overload rejection level indicates that the operation should never be shed.

18. The tangible and non-transitory machine-readable storage medium of claim 16, wherein the plurality of operations include a plurality of requests to be processed by the monitored resource and an overload rejection level is set for a plurality of types of requests.

19. The tangible and non-transitory machine-readable storage medium of claim 17, wherein the monitored resource is a queue of received requests and the level of usage is the size of the queue.

20. The tangible and non-transitory machine-readable storage medium of claim 16, wherein the step of determining an overload usage state comprises:
instructions for waiting an escalation interval;
instructions for determining whether a monitored resource is in an overloaded state; and
instructions for escalating the overload usage state if the monitored resource is in an overloaded state.
